(19) United States
(12) Patent Application Publication
(10) Pub. No.: US 2025/0208867 A1
(43) Pub. Date: Jun. 26, 2025

(54) INTELLIGENT PRE-EXECUTION OF DECISION SERVICE STRATEGIES FOR AVAILABILITY DURING DATA REQUESTS

(71) Applicant: PAYPAL, INC., San Jose, CA (US)

(72) Inventors: Rajendra Bhat, Bangalore Urban (IN); Prabin Patodia, Bangalore (IN)

(21) Appl. No.: 18/392,686

(22) Filed: Dec. 21, 2023

(51) Int. Cl. G06F 9/30

(52) U.S. Cl. CPC G06F 9/30029

(57) ABSTRACT

There are provided systems and methods for intelligent pre-execution of decision service strategies for availability during data requests. A service provider, such as an electronic transaction processor for digital transactions, may utilize different decision services that implement rules and artificial intelligence models for decision-making of data including data in production computing environment. A decision service may normally be invoked to execute a strategy for processing a request when that request is received or arrives at the decision service. To provide faster processing and higher availability of such services, an intimation call may be received at the decision service from an upstream service, which initiates a process to pre-execute the strategy based on available data at the time of the intimation call. Pathways of rules capable of being completed may be executed using the available data and the result may be stored for later merging with further strategy execution.

### TECHNICAL FIELD

The present application generally relates to calls to decision services in an application architecture of a computing system and more particularly to intelligently pre-executing strategies to increase availability and reduce failures of decision services in the computing system.

### BACKGROUND

Users may utilize online service providers and corresponding computing systems and services to perform various computing operations and view available data through client computing devices of the users. Generally, these computing operations are provided by online platforms and systems, which may provide applications and services for account establishment and access, messaging and communications, electronic transaction processing, and other types of available services. During use of these service providers, the service provider may utilize one or more decision services, including automated software and applications, that implement and utilize coded processing rules and/or artificial intelligence (AI) models for decision-making in real-time data processing in a production computing environment. A particular decision service may be associated with providing decision-making operations within a production computing environment, such as live electronic transaction processing operations with an online transaction processor.

However, decision services in the production computing environment may fail or timeout due to processing node timeout, application programming interface (API) failures or unresponsive calls, and other timeouts that occur during data loading and processing. Decision services may interact with multiple other services for data loading, where the loaded data is then translated to a format for execution of a strategy for the decision service, which may correspond to the data processing nodes, executable processes, and the like that result in an output decision by the decision services. When the decision service fails, users and/or the service provider may be adversely affected by system errors and failures. For example, a user's transaction processing of an electronic transaction may fail and the user and/or service provider (e.g., online transaction processor) may incur loss. However, not all data may be required to be loaded, and loading of some data may not be required in real-time, which may cause timeouts that are avoidable as well as use unnecessary computing resources. As such, there exists a need for an intelligent and smart strategy execution that reduces timeouts and unnecessary data loads.

### BRIEF DESCRIPTION OF THE DRAWINGS

FIG. 1 is a block diagram of a networked system suitable for implementing the processes described herein, according to an embodiment;

FIG. 2 is an exemplary system environment of a decision service with upstream services that may invoke the decision service through an intimation call to pre-execute portions of a strategy based on available data, according to an embodiment;

FIGS. 3A and 3B are exemplary diagrams of strategies having nodes that may be preprocessed to provide an intelligent strategy execution, according to an embodiment;

FIG. 4 is a flowchart for intelligent pre-execution of decision service strategies for availability during data requests, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for intelligent pre-execution of decision service strategies for availability during data requests. Systems suitable for practicing methods of the present disclosure are also provided.

A service provider may provide different computing resources and services to users through different websites, resident applications (e.g., which may reside locally on a computing device), and/or other online platforms. When utilizing the services of a particular service provider, the service provider may provide decision services for implementing rules and intelligent decision-making operations with such services. Decisions services (e.g., microservices and/or other computing services for an application and computing architecture for one or more digital platforms and/or systems of the service provider) may, for example with an online transaction processor, provide services associated with electronic transaction processing, including account services, user authentication and verification, digital payments, risk analysis and compliance, and the like. These services may further implement automated and intelligent decision-making operations and engines, including data processing rule engines that automate certain decision-making based on rules designated for the systems. These decision services may be used for risk analysis, fraud detection, and the like to determine if, when, and how a particular service may be provided to users. For example, risk rules may be utilized with a risk engine for a decision service to determine if an indication of fraud is present in a digital transaction and payment, and therefore to determine whether to proceed with processing the transaction or decline the transaction (as well as additional operations, such as request further authentication and/or information for better risk analysis).

However, decisions services require data loads to process strategies and provide a decision on the input data or other actionable output that may be used with other services, systems, and/or data processing results provided to users. Decision services may have strategies executable by such services when processing data, such as processing and responding to data processing requests from computing devices of users and/or other applications and systems. Strategies may correspond to steps in a workflow, such as receiving a data processing request, validating such request, loading data, responding to data loads and/or the request, and the like. As such, strategies are executable by the decision service to give decisions on input data and/or requests. Strategies may reside and/or be stored outside the decision services and be invoked during runtime of the decision services when the service executes a workflow (e.g., a directed acyclic graph (DAG) or the like for processing operations); however, other configurations of the decision service or other computing service for strategy invocation and use during runtime and workflow execution may also be used. As such, strategies may also be storable by one or more data repositories, databases, cloud storage components, or the like.

When loading data, significant time may be taken and data loads may proceed sequentially, where multiple factors may impact performance of data loading and/or rule execution resulting in timeouts and failure of decision services to process a strategy and/or provide a result. For example, data loads may fail or timeout due to data processing errors, computing attacks, latency, data size, and other events or circumstances that impact performance of data loading. Failure of decision services when executing a strategy may incur loss, fraud, and/or vulnerabilities to the service provider's system. For example, with an online transaction processor, a risk decisioning system may be an important component for payment processing and avoiding fraudulent transactions. Payment processing services interact with decision services and validate whether the transaction is fraudulent or not using such risk decisioning systems. With an online transaction processor, even 0.001% failure may contribute to thousands of failed transactions.

As such, the service provider may provide a pre-execution service and/or operations of portions of decision service strategies that are capable of being processed using available data and data loading operations prior to an upstream data processing request being received at the downstream decision services. Pre-execution strategies may be generated by parsing and analyzing a strategy for pathways of data processing (e.g., nodes in a data processing path or chain) that are used for execution of the strategy, as well as the required data and data loading for each node and/or pathway. Thereafter, the available data and/or data that may be processed at a current time and/or prior to the data processing request being received at the downstream service may be determined. Based on the available data to be processed, certain pathways may be identified that can be progressed and/or traversed in order to execute the strategy. The pathways that are available to be processed and completed may be used to determine a first, base decision for the decision service.

This decision or other output may then be cached or otherwise stored in anticipation for when the request is received at the decision service. At that time, the base decision may be used with any other portions of the required that that is now available and/or can now be processed (e.g., variable or dynamic data that is required to be processed when the request is received, data or outputs by other upstream services, data that could not be previously loaded due to latency, size, permissions, or the like, or other data). The base decision may be merged or combined so that an output may then be provided. In this manner, the decision service may provide increased availability and success rates, with lower times, by providing a decision even using only the base decision, as well as any further processing and merging for further strategy execution, when the data processing request is received.

In this regard, a service provider, such as an online transaction processor may provide services to users, including electronic transaction processing, such as online transaction processors (e.g., PayPal®) that allow merchants, users, and other entities to process transactions, provide payments, and/or transfer funds between these users. When interacting with the service provider, the user may process a particular transaction and transactional data to provide a payment to another user or a third-party for items or services. Moreover, the user may view other digital accounts and/or digital wallet information, including a transaction history and other payment information associated with the user's payment instruments and/or digital wallet. The user may also interact with the service provider to establish an account and other information for the user. Service providers may also provide computing services, including social networking, microblogging, media sharing, messaging, business and consumer platforms, etc. These computing services and applications may be deployed across multiple different applications including different applications for different operating systems and/or device types. Furthermore, these services and applications may invoke and/or utilize the aforementioned decision services for strategy execution when processing data.

In order to utilize the computing services of a service provider, an account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation, as well as purchase or subscribe to services of the service provider. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. Access and use of these accounts may be performed in conjunction with uses of the aforementioned decision services.

As such, when clients (e.g., computing devices of users) connect with and/or call computing services of service providers, decision services may be invoked to execute strategies in a workflow of data process for a particular request, call, or the like. When a data processing request is received, such as when a computing device calls a gateway or upstream service and/or a corresponding application of the service provider is invoked to execute one or more strategies for processing the data processing request from the device, the service provider, application and/or computing system architecture, and/or decision service may determine that a strategy for the decision service may be pre-executed, at least in part, based on available data at the current time and prior to when the data processing request arrives at the decision service. This may provide improved availability and redundancy of the decision service during invocation and processing of the data processing request, which may reduce timeouts and improve efficiency and processing times for strategy execution.

For example, with a strategy executable by a decision service, a service provider may determine how the strategy is executed for a set of rules. This may include determining the set of rules for strategy execution, which may correspond to different nodes and/or pathways that together form the strategy when combined and executed. The rules may be associated with a rule repository that is called when a strategy is determined and executed, where each decision service may have one or more strategies in a strategy folder or file that may be accessed and executed depending on the received decision service. Prior to receipt of a data processing request and/or when a data processing request enters a processing pipeline and flow, such as when the request is received at a gateway service or other upstream service initially handling the data processing request and/or orchestrating request processing by the services, the service provider may determine metadata for strategy execution. This may include the strategy folder and corresponding rules (e.g., business rules and the like), which may be accessed from a rule repository and used to determine the necessary data calls and data loads for rule processing and strategy execution.

Thus, the service provider may determine the strategy having a set of rules in one or more pathways that are required to be processed, each pathway having one or more rules or nodes for loading and/or processing data. The service provider may access the strategy and parse the strategy for pathways that lead to execution of the strategy. For example, different data processing nodes or operations may be required, which may lead to a successful execution of the strategy and result. Each node may have required data to be loaded, as well as a corresponding action, activity, event, or executable operation/task to transmit or process the data for strategy execution. The strategy may have multiple pathways that may branch and lead to a decision or other output from executing the strategy, which may be parsed from the strategy and identified. As such, each strategy may include multiple pathways leading to execution and a result/output of the strategy.

Once the pathways and nodes of the strategy are determined, with the required data and data loading events or processes, the service provider may generate metadata file for the corresponding strategy information. The metadata may be stored for the decision service and used when an intimation call is received at the decision service. For example, when a data processing request is received by the service provider and enters the computing architecture and/or system for processing, an initial or gateway service, or other upstream service, may receive and perform initial processing and/or data transformations on the request. This causes an intimation call to be sent to downstream services to check availability, status, and/or health of such services, as well as prepare, startup, or refresh the decision service(s) for processing the request. The initiation call may therefore correspond to a “pre-call” or notification call of the incoming request and forecasted requirement for processing the request at the decision service.

The service provider and/or a pre-execution strategy processor for the decision service may then determine if any of the pathways and/or nodes of the strategy may be pre-executed by the decision service. To determine pathways and/or portions of the strategy that may be pre-executed, the service provider may determine data available for the required data loads based on executable API calls from an API specification of the decision service and/or strategy. These API calls may correspond to a subset of the required data and data loading for the strategy that may be immediately or currently available at the time of the intimation call and/or prior to receiving the data processing request. As such, the available data may correspond to the data available for data processing but may not include all of the required data where unavailable (e.g., due to requirements and/or provision by upstream services) and/or inability to load (e.g., due to time constraints, availability from data resources, call failures, etc.).

As such, based on the available data and the metadata for the strategy, the service provider may determine a subset of those pathways for the service that are available to be processed, executed, and/or completed in order to result is successful execution of the strategy and a result, output, decision, or the like. The service provider may then execute those pathways and determine an initial base decision, which may be generated prior to the data processing request arriving at the decision service. Thereafter, when the request arrives, the base decision may be retrieved, such as from a cache, short-term storage, or other database or storage component, and may then be used with further strategy execution for processing the request. For example, additional data loads may be performed that are then available and/or may be performed, and those other pathways not previously executed may be processed. The different pathways and/or outputs of the strategy execution by the decision service may then be merged, and an output may be provided. Where a failure may occur and/or all or a portion of the other pathways and/or data loads may not be performed, the base decision may, at least in part, provide a decision that may be actionable and utilized for system redundancy.

As such, the service provider may provide increased availability of decision services and other decisioning operations for a data processing system. This provides redundancy and further system robustness and flexibility in the event of system and/or component failures, API failures and/or unresponsive calls, computing attacks, and/or other issues faced by large complex computing systems and architectures. Further, the additionally provided availability decreases and/or prevents loss and failure of system usage, which allows for more accuracy and greater confidence in data processing results and system requests. As such, by providing pre-execution of pathways and/or portions of pathways at a time of an intimation call and prior to receiving the data processing request, the service provider may provide for improved computing systems and architectures that are more efficient, secure, and failure tolerant.

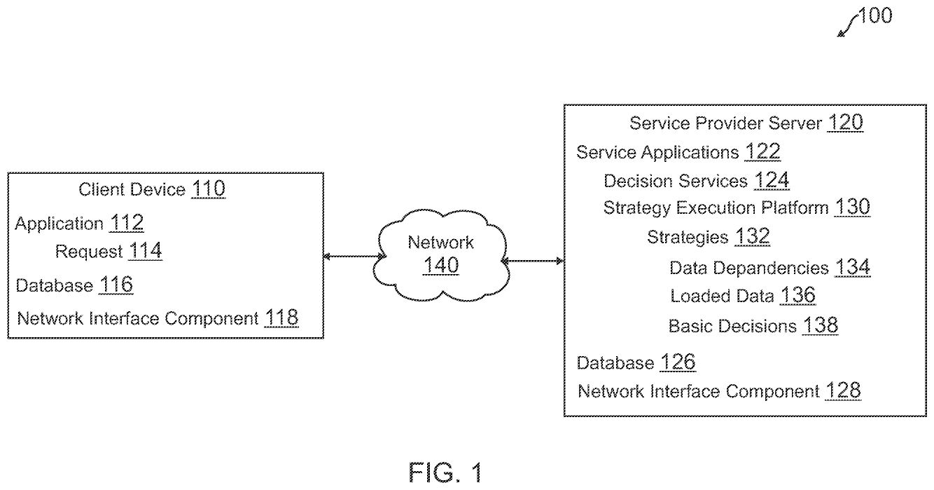

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by a user to access a computing service or resource provided by service provider server 120, where service provider server 120 may provide various data, operations, and other functions to client device 110 via network 140 including those associated with applications and computing infrastructures that utilize decision services for decision-making during data processing. In this regard, client device 110 may be used to access a website, application, or other platform that provides computing services. Service provider server 120 may provide applications, processes, and platform that process and respond to data processing requests from client device 110 via decision services, where service provider server 120 may provide pre-execution of strategies by decision services through intelligent strategy execution based on available data in response to intimation calls.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider server 120 and/or other devices or servers. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein. Although client device 110 is described as a device of an end user, such as a customer of service provider server 120, in other embodiments client device 110

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 140, which may include accessing and utilizing computing services provided by service provider server 120 via service applications 122, which includes transmitting a request 114 to service provider server 120 during usage of service applications 122, which is received and processed by service provider server 120 using pre-execution of strategies through intimation calls, as discussed herein. In this regard, application 112 may correspond to specialized software utilized by client device 110 that may be used to access a website and interfaces (e.g., via a browser application, mobile application, rich Internet application, or resident software application) that may display one or more user interfaces that allow for interaction with the computing services of service provider server 120. As such, in various embodiments application 112 may correspond to a general browser application configured to retrieve, present, and communicate information over the Internet (e.g., utilize resources on the World Wide Web) or a private network. However, in other embodiments, application 112 may include a dedicated application of service provider server 120 or other entity that may access data for, present, and process request 114 via one or more interfaces.

Application 112 may utilize and/or be associated with account information, user financial information, and/or transaction histories. However, in further embodiments, different services may be provided via application 112, including social networking, media posting or sharing, microblogging, data browsing and searching, online shopping, and other services available through service provider server 120. Thus, application 112 may also correspond to different service applications and the like. When utilizing application 112 with service provider server 120, application 112 may request processing of request 114, such as by requesting data for processing and/or providing data with request 114 to process data and/or return a data processing result when utilizing one or more computing services of service provider server 120.

Request 114 may be created by application 112 and transmitted to service provider server 120 based on an interaction between application 112 and one or more applications and/or computing services of service provider server 120, such as service applications 122. In this regard, the interaction between application 112 and service provider server 120 may correspond to account login, authentication, electronic transaction processing, and/or use of other services provided by service applications 122 described herein. As such, request 114, or other data calls made during processing of request, may include pre-execution of strategies when intimation calls are made between different ones of decision services 124 of service applications 122. Request 114 may have a corresponding data load that is processed via one or more decision services of service provider server 120 to provide a decision that is used to provide a resulting output and result. As such, application 112 may be used with the decision services of service provider server 120. However, such decision services may fail, and/or applications, components, and other computing services and platforms of service provider server 120 may become unresponsive, may fail, go offline, lag out, disconnect, suffer latency issues, or otherwise become unavailable, which may include timeouts due to service level agreements (SLAs) and/or other delays, lag, or latency issues. As such, service provider server 120 may pre-execute strategies of decision services during or in response to intimation calls so that higher availability and fewer timeouts or failures may occur, as discussed further herein.

Client device 110 may also include other applications as may be desired in particular embodiments to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include financial applications, such as banking applications. Other applications may include social networking applications, media viewing, and/or merchant applications.

The other applications may also include other location detection applications, which may be used to determine a location for the user, such as a mapping, compass, and/or GPS application, which can include a specialized GPS receiver that determines location information for client device 110. The other applications may include device interface applications and other display modules that may receive input from the user and/or output information to the user. For example, client device 110 may contain software programs, executable by a processor, including a graphical user interface (GUI) configured to provide an interface to the user. The other applications may therefore use devices of client device 110, such as display devices capable of displaying information to users and other output devices, including speakers.

Client device 110 may further include or be associated with database 116, which may store various applications and data and be utilized during execution of various modules of client device 110. Databases 116 may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications on client device 110, identifiers associated with hardware of client device 110, or other appropriate identifiers, such as identifiers used for payment/user/device authentication or identification, which may be communicated as identifying the user/client device 110 to service provider server 120. Moreover, database 116 may include data for request 114, which may be provided to service provider server 120 for processing.

Client device 110 includes at least one network interface component 118 adapted to communicate with service provider server 120 and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide computing services that utilize decision services for decision-making in an intelligent system to provide responses, output, and/or results to client device 110 based on data processing requests. In this regard, service provider server 120 includes one or more processing applications which may be configured to interact with client device 110, for example, to provide data processing results in responses to requests, which may be processed through pre-execution of decision service strategies. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes service applications 122 having a strategy execution platform 130, a database 126, and a network interface component 128. Service applications 122 and strategy execution platform 130 may correspond to executable processes, procedures, and/or applications with associated hardware. In other embodiments, service provider server 120 may include additional or different modules having specialized hardware and/or software as required.

Service applications 122 may correspond to one or more processes to execute modules and associated specialized hardware of service provider server 120 to provide computing services for account usage, digital electronic communications, electronic transaction processing, and the like. In this regard, service applications 122 may correspond to specialized hardware and/or software used by service provider server 120 to provide, such as to a user associated with client device 110, one or more computing services, which in turn utilize decision services 124 and/or other microservices for decision-making during runtime. Service applications 122 may correspond to electronic transaction processing, account, messaging, social networking, media posting or sharing, microblogging, data browsing and searching, online shopping, and other services available through service provider server 120. Service applications 122 may be used by a user to establish an account and/or digital wallet, which may be accessible through one or more user interfaces, as well as view data and otherwise interact with the computing services of service provider server 120. In various embodiments, financial information may be stored to the account, such as account/card numbers and information. A digital token or other account for the account/wallet may be used to send and process payments, for example, through an interface provided by service provider server 120. The payment account may be accessed and/or used through a browser application and/or dedicated payment application, which may provide user interfaces for use of the computing services of service applications 122.

The computing services may be accessed and/or used through a browser application and/or dedicated payment application executed by client device 110, such as application 112 that displays UIs from service provider server 120. Such account services, account setup, authentication, electronic transaction processing, and other computing services of service applications 122 may utilize decision services 124, such as for authentication, electronic transaction processing, risk analysis, fraud detection, and the other decision-making and data processing required by the aforementioned computing services. Decision services 124 may execute using strategies 132, which may be accessed and loaded to one or more of decision services 124 during run-time and/or live computing event and request processing in a production computing environment. Decision services 124 may correspond to decision services used for decision-making using rules-based and/or AI models and engines when executing strategies 132 for decisions, responses, and other outputs. Decision services 124 may execute strategies 132 based on one or more pathways of corresponding data processing nodes and/or events that are performed for successful strategy execution.

In this regard, strategy execution platform 130 may be used to pre-execute portions and/or pathways of strategies, such as particular rules and corresponding data processing nodes, during or in response to intimation calls and prior to a data processing request (e.g., request 114 or data processing requests from other internal and/or external clients, devices, and/or servers) arriving at the corresponding one of decision services 124. This allows for higher availability, lower latency and processing times in real-time processing of data processing requests when arriving at decision services 124, and more reliable and robust decision-making during failures and/or failed data loading. Strategy execution platform 130 may be used with data processing requests from different clients, as well as internal software and processing stacks. For example, some data processing requests may originate and be received by service provider server 120 from external client devices and the like, such as of customers or other end users. Other external clients may include merchants and corresponding merchant devices and/or servers, webpages, software of service provider server 120 installed on external merchant devices/servers, third-party transaction processors, and the like. However, strategy execution platform 130 may also be triggered to perform pre-execution of strategies 132 based on intimation calls received from internal processing or other entities and clients including software and processing stacks. For example, service applications 122 may make calls between different applications and/or ones of decision services 124, which may utilize a series of decision services 124 that trigger intimation calls between upstream and downstream services, thereby invoking strategy execution platform 130 for pre-execution of strategies 132.

As such, strategy execution platform 130 may correspond to a digital platform, software application and/or application architecture, or the like that may include one or more processes that execute modules and associated specialized hardware of service provider server 120 with service applications 122 for strategy execution with decision services 124. Strategy execution platform 130 may determine pathways of strategies 132 that may be executed based on available data at a time of an intimation call being made to a corresponding one of decision services 124, such as based on data dependencies 134, and may execute those pathways prior to a data processing request arriving at that decision service. In this regard, service applications 122 may correspond to specialized hardware and/or software that may access strategies 132 that may be created and deployed for execution by decision services 124 of service applications 122 during run-time and/or live production computing environment use for processing and serving data to users and computing devices, such as during use of computing services, applications, and the like. Strategies 132 may have corresponding rules and/or rule executions to be performed in the pathways, which may correspond to data processing nodes for the rules in each pathway. As such, the pathways may be made up of one or more rules to be executed in sequence (where pathways may be executed in sequence or parallel) as determined in an execution graph or other visualization, hierarchy, network, o the like of each of strategies 132.

Strategies 132 may be stored in corresponding folders or files with data dependencies 134 of different rules designating and/or identifying the data required to be processed at each node. In this regard, parsing of, traversing, and/or analyzing strategies 132 may be done with data dependencies 134 to determine pathways and/or series of rules that may be executed for partial and/or complete strategy execution and determination of a decision by one or more of decision services 124. Once parsed, a metadata file may be generated that identifies the pathways of each of strategies 132 and the corresponding ones of data dependencies 134 relied on by the data processing nodes in the pathways for rule processing based on data loads, and therefore strategy execution and resulting decisions by decision services 124. The metadata files for strategies 132, when determined from parsing and/or analyzing strategies 132, may then be stored and used for strategy execution, and in particular, to pre-execute one or more pathways and/or nodes that may be completed or traversed for strategy execution prior to data processing requests arriving at decision services 124. As such, decision services 124 may pre-execute portions or all of strategies 132 when intimation calls are received, such as a startup, refresh, alert, or notification call from a gateway service or upstream service that one of decision services 124 will be invoked and/or is required for data processing of request 114 or other data processing requests from other internal and/or external clients, devices, and/or servers.

For example, strategies 132 may be used in order to execute decisions and provide outputs used to process data, such as those decisions and outputs that may be provided for account services, account setup, authentication, electronic transaction processing, and other computing services. However, decision services 124 may fail and/or data may not be loaded in sufficient time when requests are received at decision services 124, which normally would result in timeout (e.g., due to SLA requirements), failure of data processing, and/or incompletion of requests from devices and servers, such as request 114. This may also adversely affect other systems, such as risk decisioning and the like, which may result in loss. Generally, request for data processing may be received by decision services 124 from any client, including internal applications, devices, and/or servers of service provider server 120 acting as clients to send requests for processing data, as well as external clients including client device 110. As such, although discussion of processing request 114 from client device 110 by strategy execution platform 130 is discussed herein, it is understood that other requests may originate internally and/or from other external sources (e.g., merchants, partner platforms, applications of service provider server 120 installed on external and/or third-party devices, etc.) from service provider server 120. In this regard, strategy execution platform 130 may process intimation calls from any caller that is external to the one of decision services 124 being called to pre-process ones of strategies 132. For example, the caller may be external to the corresponding decision service, such as an upstream service, that may call the decision service or the caller may be an external that calls service provider server 120. Thus, any service that calls the decision service is a client to that decision service and, as such, the caller may correspond to some client that is different and/or separate from the decision service being called via the intimation call and later actual request call for data processing.

As such, strategy execution platform 130 may implement and utilize operations, components, and data structures for pre-execution of strategies. For example, strategy execution platform 130 may utilize a strategy parser to determine all pathways that may be traversed and/or iterated through during strategy execution by one or more of decision services 124 of one or more of strategies 132, such as to provide a result, output, or decision from strategy execution. Such outputs may be used when processing requests from different clients, devices, and servers, such as when determine a response to a data processing request that may originate from an internal client, such as an application (e.g., one or more of service applications 122) executed by an internal device or server, or from external client devices, merchant devices/servers, third-party or partner devices/servers, and the like.

The strategy parser may operate by determine all (or a subset of all) viable pathways for different data processing nodes of rules, rules requiring data loading or processing events, and the like that may be required to successfully process and complete a portion of the rules during execution of one of strategies 132 by a corresponding one of decision services 124 during execution. As such, each of strategies 132 may have one or more pathways each having their own corresponding required data as designated by data dependencies 134. Data dependencies 134 may identify the data for the rules processed by the nodes, processors, or events in the pathways for strategy execution that may result in successful execution of the strategy. As such, when data for data dependencies 134 is not available or cannot be called, retrieved, and/or loaded, such pathway may be unavailable to successfully execute the corresponding one of strategies 132. This may occur during or in response to intimation calls due to lack of the data (e.g., an upstream service is required to process and provide the data), the data cannot be retrieved in time, or the data cannot be loaded due to another event. Once pathways to strategies 132 are determined by the strategy parser, data dependencies 134 may identify the corresponding data loads for the rules in the pathways, and metadata files for the strategy executions may be generated.

In some embodiments, strategy execution platform 130 may include operations, AI models and engines (e.g., machine learning (ML) or neural network (NN) models), and the like that may iterate through the options and pathways to strategies 132 to determine the manners in which a strategy may be successfully executed and required data for each manners (e.g., pathways). AI models may generally correspond to any artificial intelligence that performs decision-making, such as rules-based engines and the like. However, AI models may also include subcategories, including ML models and NN models that instead provide intelligent decision-making using algorithmic relationships. Generally, NN models may include deep learning models and the like, and may correspond to a subset of ML models that attempt to mimic human thinking by utilizing an assortment of different algorithms to model data through different graphs of neurons, where neurons include nodes of data representations based on the algorithms that may interconnect different nodes using mathematical relationships. ML models may similarly utilize one or more of these mathematical models, and similarly generate layers and connected nodes between layers in a similar manner to neurons of NN models.

When building ML models for strategy execution platform 130, training data may be used to generate one or more classifiers and provide recommendations, predictions, or other outputs based on those classifications and an ML model. The training data may be used to determine input features for generating predictive scores for strategy pathways and strategy executions, such as what data may be required and/or used during strategy execution. For example, ML models for strategy execution platform 130 may include one or more layers, including an input layer, a hidden layer, and an output layer having one or more nodes; however, different layers may also be utilized. As many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models for strategy execution.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models for strategy execution platform 130 that attempt to determine how strategies can be execute. Thus, when ML models for strategy execution platform 130 are used to perform a predictive analysis and output, the input may provide a corresponding output based on the classifications trained for ML models for strategy execution platform 130.

ML models for strategy execution platform 130 may be trained by using training data associated with past known and/or derived data, labels to known and derived data, as well as the aforementioned features for strategy execution by different pathways (e.g., required data by different nodes in processing pathways and what may be used to provide a successful strategy execution). By providing training data to train ML models for strategy execution platform 130, the nodes in the hidden layer may be trained (adjusted) such that an optimal output (e.g., a classification within an accuracy threshold) is produced in the output layer based on the training data. By continuously providing different sets of training data, and with NNs penalizing such NNs when the output of ML models for strategy execution platform 130 is incorrect, ML models and/or NNs for strategy execution platform 130 (and specifically, the representations of the nodes in the hidden layer) may be trained (adjusted) to improve its accuracy performance in data classification. Adjusting ML models and/or NNs for strategy execution platform 130 may include adjusting the weights associated with each node in the hidden layer. Thus, the training data may be used as input/output data sets that allow for ML models and/or NNs for strategy execution platform 130 to make classifications based on input attributes.

As such, metadata files for strategy execution of strategies 132 based on data dependencies 134 may be determined programmatically and/or intelligently using one or more AI systems and/or models, such as ML models and/or NNs. Once determined, the pathways may be packaged into metadata files having data packages, code, and/or files for strategies 132. In this regard, metadata file generation may take, as input, all (or a portion of) pathways for execution of strategies 132 and data dependencies 134 and output metadata files stored for use during pre-execution of strategies 132 for decision services 124. For example, with a request originating from an interaction with an external device (e.g., client device 110), client device 110 may transmit request 114 to service provider server 120, which may arrive at a gateway service of service applications 122. The gateway service may act as an orchestrator between different services, layers, and applications of service applications 122, which may then invoke, intimate, and/or execute different ones of decision services 124 for processing of request 114. As such, one of decision services 124 may be required to process request 114. With other requests from internal clients, devices, and/or servers, a gateway service may or may not be required to act as an orchestrator. However, a series of decision services 124 may be invoked in an order for processing the data processing request, and as such, intimation calls may be made between different ones of decision services 124.

When the gateway service and/or one of decision services 124 receives request 114 and/or processes request 114, an intimation call may be sent downstream to startup, refresh, and/or invoke another one of decision services 124. The intimation call may cause strategy execution platform 130 to access a corresponding metadata file for the strategy to be used and executed by the decision service, and determine required data loads and available data for those data loads at a time of the intimation call, including data that may be retrieved from a data call and/or inferred from available data using an AI model or the like. Loaded data 136 may then be determined and loaded from the available data, which may be used for pre-execution of the strategy. However, loaded data 136 may not correspond to all required data.

As such, a subset of pathways is then determined, where the subset may be validly and successfully executed by the one of decision services 124 that has been called by the intimation call. The subset of pathways may include one or more pathways that proceed from start to finish through data processing nodes, events, or processor based on loaded data 136. Thereafter, strategy execution platform 130 may execute those pathways using loaded data 136 to determine base decisions 138. Base decisions 138 may result from execution branches and/or pathways of the strategy, but not fully executing the strategy, and therefore may result in an output, decision, prediction, score, or the like that may be of lower confidence; however, still relevant to strategy execution.

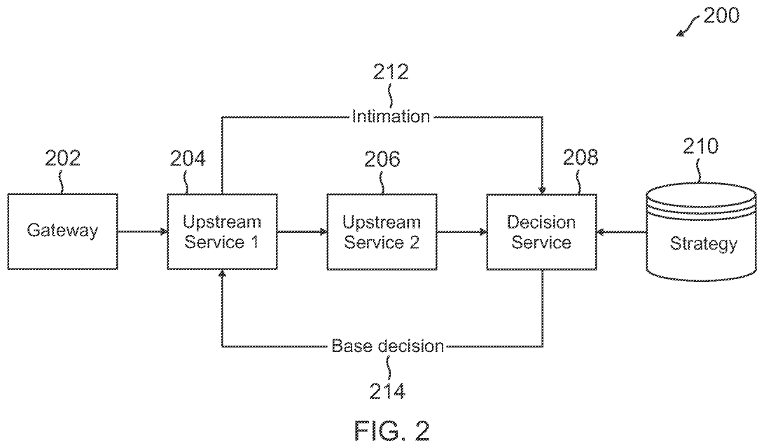

Thus, base decisions 138 may be used if further data loads and/or decision services 124 fail, and may also be merged later with further data processing in order to reduce the real-time data processing required for request 114 when request 114 arrives at the corresponding one of decision services 124. As such, base decisions 138 may be stored and later may be recalled for providing a decision in the event of decision service failure or the like, but may also be used and merged when the decision service executes further pathways of the strategy based on now available data for data dependencies 134 of the strategy. Merging may then provide a more robust and/or higher confidence decision, and may be allow for less data processing at the time of the decision output by pre-executing portions of the strategy. The operations and components used to pre-execute strategies 132 for decision services 124 to determine base decisions 138 and use those base decisions, are described in further detail below with regard to FIGS. 2-4.

Additionally, service provider server 120 includes and/or is associated with database 126. Database 126 may store various identifiers associated with client device 110. Database 126 may also store account data, including payment instruments and authentication credentials, as well as transaction processing histories and data for processed transactions. Database 126 may store financial information and tokenization data. Database 126 may further store strategies 132 and/or information used for execution of strategies 132, such as metadata files generated for pathways of strategy execution. For example, database 126 may include or correspond to a rule and/or strategy storage repository where rules, deployed strategies for rule execution, and the like may be accessed and utilized by decision services 124 for execution of a strategy during decision-making and/or outputs. Although database 124 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

In various embodiments, service provider server 120 includes at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Network 140 may correspond to small scale communication networks, such as a private or local area network, or a larger scale network, such as a wide area network or the Internet, accessible by the various components of system 100.

FIG. 2 is an exemplary system environment 200 of a decision service with upstream services that may invoke the decision service through an intimation call to pre-execute portions of a strategy based on available data, according to an embodiment. System environment 200 of FIG. 2 includes a gateway 202 that may correspond to a gateway service of an application, platform, and/or other components and operations of service provider server 120, such as one or more of service applications 122, discussed in reference to system 100 of FIG. 1. In this regard, gateway 202 may interact with an upstream service 1 204, and an upstream service 2 206, and a decision service 208 to coordinate and orchestrate handling and processing of a data processing request. In this regard, upstream service 1 204, and upstream service 2 206, and decision service 208 may each correspond to one of decision services 124 from system 100 that are invoked and executed by service applications 122 during use by client device 110.

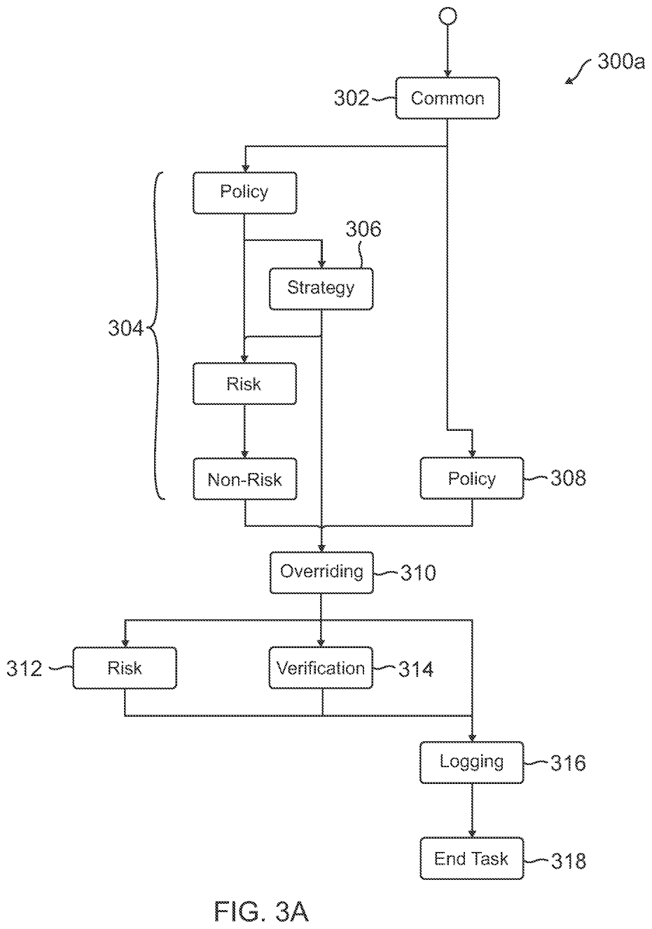

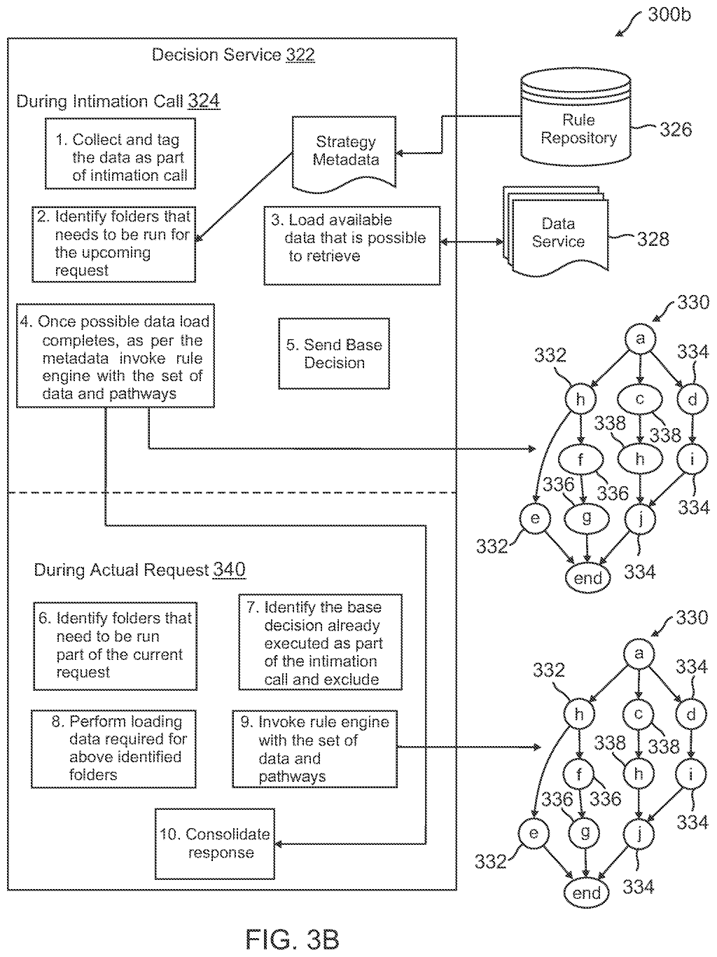

In system environment 200, prior to or on initiation of an interaction and/or request to gateway 202, metadata for a strategy 210 may be generated, which may correspond to a file designating the pathways of parallel and/or series rule processing performed when executing a strategy based on a set of rules (e.g., stored to a rule repository). The metadata file may also include data dependencies of the rules on data required to be loaded and processed by the rule (e.g., for a rule allowing a transaction between $0>X>$500 from country Y, the data may be a transaction total and a country of origin). The metadata file may be generated by parsing strategy 210 for pathways of successful strategy execution by the rules processed in each pathway, and the data dependencies in the rules, and may be visualized as a graph, network of nodes, or the like, as further shown in FIGS. 3A and 3B below. Once the metadata file is generated, it may be stored in association with strategy 210, such as in a database or other data storage accessible by decision service 208 in runtime and/or in response to or during an intimation call and execution for a data processing request.

In this regard, a client may request data processing, such as by providing one or more data loads to a computing application, platform, or service using decision service 208 that requires action from a service provider. Thus, decision service 208 may be invoked in order to process a data processing request and provide a decision used when responding to the client. However, decision service 208 may fail, timeout or be unable to load certain data. As such, the metadata file may be used to pre-execute portions of strategy 210 based on an intimation call 212 to provide a base decision 214 that may be stored and/or provided back upstream to upstream service 1 204 or other endpoint for fallback, reliability and availability during failures, and/or further processing when the request arrives at decision service 208.

As such, the data processing request may arrive at gateway 202, which may then invoke upstream service 1 204 for processing. Upstream service 1 204 may perform initial processing, such as an authentication service or the like. When invoked and/or processing the request, upstream service 1 204 may execute intimation call 212 to decision service 208, which may alert or notify decision service 208 of the incoming request and requirement to process the request. This may be done before the request arrives at decision service 208, such as where upstream service 2 206 is interceding and processing the request next before decision service 208. As such, decision service may perform a pre-execution of strategy 210, in part or fully, using the metadata file and API calls for available data that may be loaded at a time of intimation call 212. An API specification or the like of API requests and other calls executed by decision services may be used to obtain and/or load data used during strategy execution.

As such, the available data for those nodes may be obtained through API requests used or designated for decision service 208, and decision service 208 may determine the pathways available to be processed using the loaded data. This may correspond to known available data, which may be directly called, requested, and/or obtained using API requests, as well as the data that may be derived, forecasted, and/or predicted data based on the known data. For example, an AI model may determine such derivations of known data using rules, ML models, and/or NNs. In this regard, decision service 208 may receive intimation call 212, such as an API call identifying an upstream data processing request at upstream service 1 204, and, on startup, refresh, or other initiation, may execute those available pathways on the currently available data. Base decision 214 may be output from this execution of strategy 210, which may be stored and used later during processing of the request by decision service 208. Further, decision service 208 may provide base decision 214 and/or an identification of computation of base decision 214 to upstream service 1 204 for fallback in the event of failure or timeout of decision service 208, such as to prevent total failure to process the request, which improves availability and reliability of decision service 208.

FIGS. 3A and 3B are exemplary diagrams 300a and 300b of strategies having nodes that may be preprocessed to provide an intelligent strategy execution, according to an embodiment. The strategy executions depicted in diagrams 300a and 300b of FIGS. 3A and 3B may be parsed and determined for pathways that may be used based on available data during the strategy execution. As such, the strategies may be processed by service provider server 120 by decision services 124 during or in response to intimation calls to pre-execute at least a part of a strategy, as discussed in reference to system 100 of FIG. 1.

Referring now to diagram 300a of FIG. 3A, in diagram 300a strategy folders for strategy execution by decision services are shown. Each strategy folder shown may include one or more strategies for rule execution required by a corresponding decision service during runtime and decision-making or other outputs. Such outputs are usable in a computing architecture of applications and services to process requests from different data clients, such as applications, devices, servers, and the like that interact with the computing architecture, in order to provide results to such requests. As such, an incoming request may cause a task initiation of a computing task or operation that is processed by device services 124 of service provider server 120 to completion to provide a result of data processing.

In this regard, strategy execution is generally performed in sequence, and data processing requests are processed by proceeding through each strategy folder and executing the strategy before moving to a next strategy. This leads to a system where downstream decision services are only invoked and executed when the task processing for the request arrives at needing that service, which can slow processing times and may lead to timeouts or failures. As such, when processing the strategies in diagram 300a, instead intimation calls may be made between decision services utilizing the strategies in the strategy folders shown to cause pre-execution of portions of strategies based on available data.

For example, a data processing request may arrive and initiate a computing task to process the request using the strategies for the folders shown in diagram 300a. Diagram 300a initiates with a common strategy folder 302, where common strategies for requests are processed, such as account data or transaction data identification and/or verification (e.g., an account is a business account and the transaction is in the last 24 hours and below $10,000). Processing may branch to a first branch 304 having a first sub-branch 306 and a second branch 308 before reuniting at an overriding strategy folder 310. Thereafter, a risk strategy folder 312 and a verification strategy folder 314 may be processed in parallel before again reuniting at a logging strategy folder 316 and a task completion 318 after executing logging strategies for logging of the request and/or request processing results.

Different ones of the strategy folders may include different strategies having a corresponding set of rules (e.g., stored to a common or accessible rule repository) that may be processed using a rule engine based on available data. However, the available data may be available at the same time for different strategies from their folders, such as account data for common strategies in common strategy folder 302 and used by risk strategies in first branch 304 and/or risk strategy folder 312. As such, different intimation calls may be executed by decision services using rule engines to execute the strategies, and those decision services may pre-execute strategies in response to or during those calls using the rule engines based on the available data. For example, a decision service executing a policy strategy from a policy strategy folder in first branch 304 may intimate through an intimation call that a non-risk strategy may further be required to be processed by a decision service in first branch 304 (e.g., shown by non-risk strategy folder further down first branch 304). Intimation calls may also be executed between diverging branches based on the upstream services, such as where a decision service execution a policy strategy in second branch 308 calling a decision service performing a logging strategy from logging strategy folder 316. This allows for pre-execution of strategies to be performed without requiring task processing of the request to advance to the corresponding strategy during task execution.

Referring now to diagram 300b of FIG. 3B, in diagram 300b logic of a decision service 322 with the pathways parsed from a strategy and available to be executed are shown. During an intimation call 324, initially the logic of decision service 322 may, at step 1, collect and tag the data to be processed as part of the intimation call. This may include the data load for the data processing request and the like that allows for determination of what strategy or strategies are to be executed by the decision service for processing the request. At step 2, folder that need to be run for the upcoming request are identified, such as those folders for one or more strategies to be executed by decision service 322. When identifying the folders, strategy metadata may be used to determine the pathways, rules and data processing nodes of those rules, and data dependencies may be determined from previously parsed strategy pathways and determined data dependencies in one or more metadata files. A rule repository 326 may be accessed to provide the rules for strategy execution, thereby identifying data required to be loaded and providing the rules for rule processing by a rule engine.

At step 3, available data that is possible to retrieve based on the data dependencies and requirements for the rules from rule repository 326 is loaded. The data may be loaded from one or more API calls to correspond data sources, such as databases, other decision services, and the like. Once the possible data load completes, at step 4, as per the metadata for the strategy, a rule engine is invoked with the set of data available, and pathways of the strategy being executed by decision service 322. Conventionally when a data processing request is received, a full strategy is executed where all corresponding pathways are parsed or traversed for strategy execution. For example, as shown in strategy graph 330, the strategy may include a start node a and have pathways 332, 334, 336, and 338 for processing before concluding at an endpoint. Each of pathways 332, 334, 336, and 338 have corresponding nodes or vertices shown in strategy graph 330, where these nodes may correspond to data loads, operations, events, or the like that occur during pathway traversal or execution to provide a resulting output of the strategy. As such, pathways 332, 334, 336, and 338 then converge again at an end point, which correspond to full and successful strategy execution and an output decision or result of strategy execution by the corresponding decision service.

However, not all of the required data by the nodes in pathways 332, 334, 336, and 338 may be available or callable/retrievable (e.g., using one or more API calls or requests) at the time of intimation call 324. For example, certain pathways may be executed while others excluded. The nodes of the strategy that are excluded due to unavailable data at the time of intimation call 324 are shown in ovals (e.g., the nodes f and g in pathway 336 and nodes c and h in pathway 338), with those nodes that can be processed by the rule engine being shown in circles (e.g., nodes a, h, and e in pathway 332 and nodes a, d, i, and j in pathway 334). The results of step 4 may correspond to a base decision where the strategy is partial executed and allows for a decision to be reported. As such, at step 5, the base decision is sent, for example, to storage for later use and/or to another upstream service that may use the base decision during fallback or when decision service 322 is called for processing the request to merge with pathways 336 and 338 when executed.

Thereafter, during an actual request 340, at step 6, folders that need to be run as part of the current request are identified, such as those strategies that may be executed by decision service 322 for processing of actual request 340. At step 7, the base decision already executed as part of the intimation call is identified and excluded. In this regard, the base decision from step 5 may result in partial execution of those available pathways with corresponding rules for one or more strategies being executed by decision service 322 at the time of intimation call 324, which no longer need execution at the later time of actual request 340. Thus, at step 8, loading of data required for the identified folders is performed, where additional data now available at the time of actual request 340 may be determined and loaded.

By loading the additional data, a rule engine may be provided the full data to allow for full strategy execution by decision service 322. In this regard, the additional data may correspond to that data required by pathways 336 and 338, however, the pre-executed pathways 332 and 334 are now not required to have data loaded by virtue of the base decision being previously determined. As such, at step 9, the rule engine is invoked with the new set of additional data at the time of actual request 340, and the execution of those pathways for the strategy or strategies being executed by decision service 322 may be performed. Using the newly executed pathways and corresponding rules with additional loaded data, a consolidated response is generated, at step 10, such as by merging the base decision with the newly executed pathways. As such, less processing is required at the time of actual request 340, leading to fewer timeouts and higher availability of decision service 322.

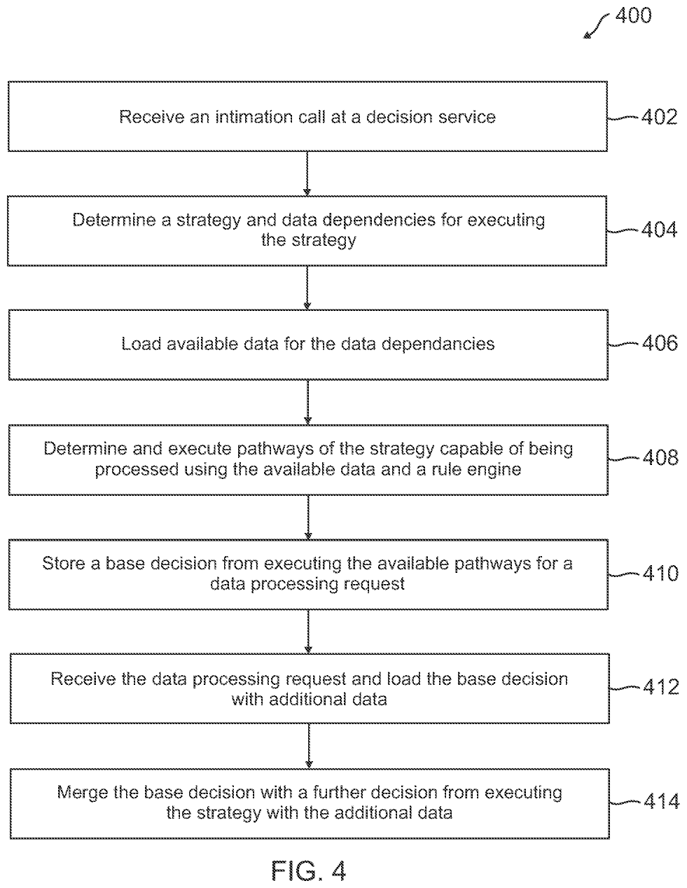

FIG. 4 is a flowchart 400 for intelligent pre-execution of decision service strategies for availability during data requests, according to an embodiment. Note that one or more steps, processes, and methods described herein of flowchart 400 may be omitted, performed in a different sequence, or combined as desired or appropriate.

Flowchart 400 in FIG. 4 includes steps executed by decision service 208 based on strategy 210 during a pre-execution of pathways for available data during or in response to an intimation call. As such, different portions of the steps of flowchart 400 are shown as being performed by, on, or with decision service 208, such as one of decision services 124 being executed by service provider server 120 to process data processing requests, calls, and other processing events. At step 402 of flowchart 400, an intimation call is received at a decision service. A gateway service or an upstream service in a data processing pipeline of invocation and execution calls for decision services, such as by an application when provide a service to and/or processing data on behalf of a client, may issue the intimation call to startup, refresh, and/or notify the decision service downstream that such service will be invoked and used during processing of a request or other call. As such, the intimation call may be used to determine that a strategy may be executed by the decision service.

At step 404, a strategy and data dependencies for executing the strategy is determined. The strategy may be determined from one or more strategy files or folders of available strategies and the corresponding parameters or data processing requirements of the request to be processed by the decision service. The strategy may include a set of rules to be executed, such as in series or parallel, that may result in a corresponding output decision by the decision service. As such, each of the rules may have a dependency of data that is required to be loaded and processed during strategy execution. A strategy may be parsed to identify all unique flow paths of the strategy, such as all pathways for strategy execution. In this regard, a flow chart, processing flow, node and/or graph, or the like may be traversed and/or iterated through to identify the possible flow paths or pathways that may be used to successfully complete or execute a strategy and return a decision or output. This process may identify and provide a list or set of different pathways and their data dependencies of rules in those pathways for processing.

At step 406, available data for the data dependencies is loaded. For example, each flow path or pathway may include one or more nodes that process one or more rules based on loaded data (e.g., risk rules or AI models, policy decisions, etc.), which require data to be loaded from call to an internal or external resource (e.g., application database, etc.), output from another node and/or service, or the like. However, only a portion of all the data may actually be available. Actual and known available data may correspond to the data that may be determined through direct calls and/or loading operations that may be successfully determined. Other data may be derived, predicted, created, or otherwise determined using the known data and one or more AI engines, models, or operations. For example, an AI engine may derive data from known data by making assumptions or inferences based on the known data and one or more learned characteristics or features of such data.

At step 408, pathways of the strategy capable of being processed using the data and a rule engine are determined and executed. A rule engine may correspond to the execution engine of a decision service that executes the rules in the pathways of the strategy. As such, the rule engine may be required to be executed by the decision service with the rules of the strategy and loaded data from the data dependencies of those rules. Since the loaded data may not be equal to or match all of the required data for strategy execution in full, only a portion of the pathways may be performed at the time of or during the intimation call. However, in some embodiments, the entire strategy may also be pre-executed if all of the required data can be loaded. Once those pathways are determined, the pathways may be executed and the strategy, in part of fully, may be executed by processing the rules using the loaded data.

At step 410, a base decision is stored from executing the available pathways for the data processing request. As a result of processing the available pathways using the loaded data, a base decision may be provided and output by the decision service for strategy execution of the data processing request that has been intimated from the upstream services and clients. The base decision may result from not all pathways being executed, and therefore may have a lower confidence or accuracy than full strategy execution. However, the base decision may provide a fallback position in the event of service failure and/or data load failure. Further, the base decision may be pre-computed so that when the data processing request arrives at the decision services, not all calls, data loads, and processing events are required, lowering processing time, latency, and timeouts that may occur when processing the data processing request in real-time by the decision service.

At step 412, the data processing request is received, and the base decision is loaded with additional data. After pre-computing the base decision, the data processing request may arrive at the decision service at a second, later, time after the first time at which the intimation call was made by the upstream service to the decision service. At this second time, the decision service may then attempt to complete the strategy execution and process any other pathways of the strategy by loading any additional data now available with the base decision. If a failure has occurred, the base decision may be used as the fallback position for decision output. Otherwise, at step 414, the base decision is merged with a further decision from executing the strategy with the additional data. The decision service may process and complete the other pathways of the strategy based on data now available at the second time and when the request is being processed. Any newly processed and executed pathways may then be merged with those from the base decision, and a full and complete decision by the decision service may be output responsive to the request. As such, the decision service, and service provider may provide more robust, efficient, and faster data processing with higher availability, less timeouts, and lower real-time processing requirements.

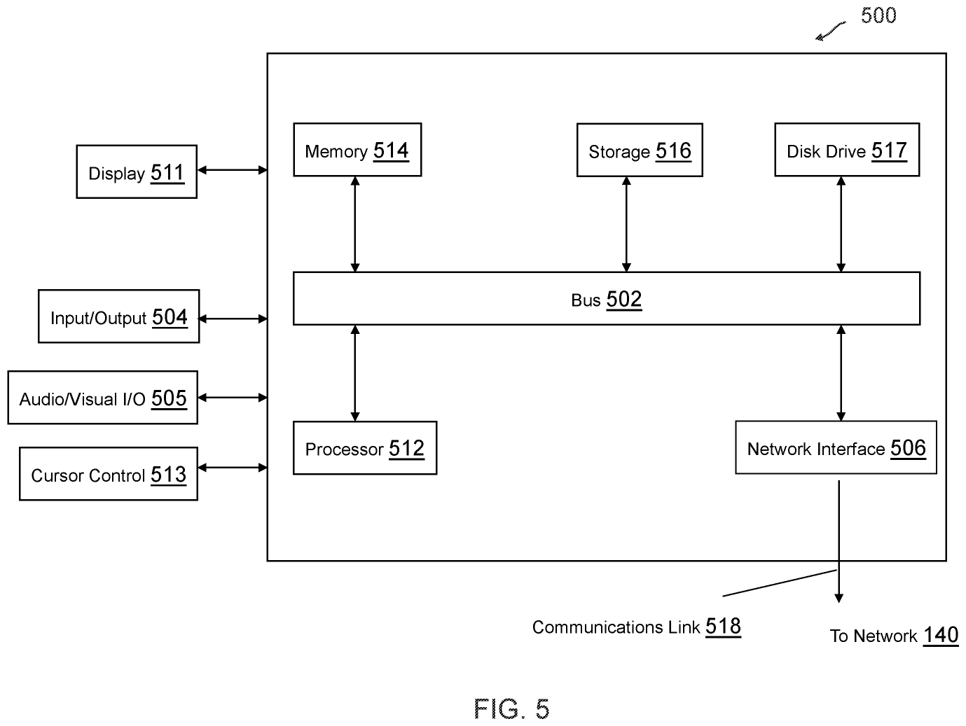

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving an intimation call of a data processing request to be processed at a decision service of the system;
determining, based on the decision service and the data processing request, a strategy for a set of rules, wherein the strategy includes a plurality of pathways each having one or more of the set of rules used by the decision service when executing the strategy for the data processing request;
loading available data for the data processing request at a first time of the intimation call;
determining a subset of the plurality of pathways capable of being executed for the strategy based on the available data;
invoking a rule engine for the decision service;
generating a base decision for the decision service using the rule engine and based on the subset of the plurality of pathways and the available data; and
storing the base decision in association with the intimation call for a second time when or after the data processing request is processed at the decision service.

2. The system of claim 1, wherein the set of rules comprise executable code for coded rules of a service provider corresponding to the system, and wherein the strategy is executable by the decision service to provide an output business decision on the data processing request based on the available data at the first time and additional data that is checked for availability at the second time.

3. The system of claim 1, wherein the intimation call comprises an application programming interface (API) call from an upstream service that handles the data processing request prior to the decision service, and wherein the generating the base decision comprises:
processing the available data using the set of rules corresponding to the subset of the plurality of pathways and the rule engine while the upstream service handles the data processing request.

4. The system of claim 1, wherein prior to receiving the intimation call, the operations further comprise:
performing a startup or a refresh of the decision service;
identifying the strategy and dependencies on data necessary for processing the set of rules in the plurality of pathways of the strategy;
for each of the plurality of pathways, determining a union of the data necessary for processing each of the set of rules; and
storing a metadata file for the strategy that includes the dependencies and the union,
wherein the determining the subset of the plurality of pathways is further based on the metadata file.

5. The system of claim 1, wherein the operations further comprise:
receiving the data processing request at the decision service;
loading the base decision with additional data available for other ones of the plurality of pathways; and
determining a subsequent decision of the decision service for the data processing using the strategy and the rule engine based on at least the base decision and the additional data.

6. The system of claim 5, wherein the determining the subsequent decision comprises:
merging the base decision for the plurality of pathways with results of the rule engine executing one or more of the other ones of the plurality of pathways using the additional data.

7. The system of claim 1, wherein the operations further comprise:
executing a batch processing job for at least the strategy that executes the subset of the plurality of pathways based on the available data at a predetermined time interval,
wherein the generating the base decision is based on an output of the batch processing job for the strategy.

8. The system of claim 1, wherein, prior to receiving the intimation call, the operations further comprise:
receiving the data processing request at an upstream service;
identifying that the decision service will be used for processing the data processing request based on an orchestration of one or more decisions services for the data processing request; and
generating the intimation call for a startup or a refresh of the decision service.

9. The system of claim 8, wherein the decision service comprises risk decisioning service for a transaction processing application of the system, and wherein the upstream service is associated with one of a gateway service or an orchestration layer for the transaction processing application.

10. A method comprising:
initiating a decision service in response to an intimation call of a data processing request identified for processing at the decision service;
determining, based on the decision service and the data processing request, a strategy having a plurality of pathways each including one or more data processing nodes for rules, wherein the strategy is executable by the decision service to provide an output decision on the data processing request;
loading available data for the data processing request at a first time of the intimation call;
parsing the strategy for a subset of the plurality of pathways capable of being executed by the decision service using the available data;
generating a metadata file identifying the available data and the subset of the plurality of pathways; and
storing the metadata file executable by the decision service at a second time after the data processing request is received by the decision service.

11. The method of claim 10, wherein, prior to the initiating, the method further comprises:
receiving the data processing request at a gateway service or an upstream service.

12. The method of claim 10, further comprising:
determining a base decision using the metadata file and based on the available data and the subset of the plurality of pathways; and
recalling, at the second time, the base decision for merging with a further decision determined for the data processing request using the strategy.

13. The method of claim 12, further comprising:
sending the base decision to one or more other decision services.

14. The method of claim 12, wherein, prior to the recalling, the method further comprises:
executing other ones of the plurality of pathways independent of the subset of the plurality of pathways at the second time after the data processing request is received based on additional data available at the second time; and
determining the further decision based on the executing the other ones of the plurality of pathways based on the additional data.

15. The method of claim 12, wherein the base decision is stored prior to the recalling in association with the intimation call and for the data processing request.

16. The method of claim 12, wherein the base decisions is determined by invoking a rule engine and processing the rules for the subset of the plurality of pathways designated for the strategy from a rule repository.

17. The method of claim 10, wherein the available data is loaded from executing one or more application programming interface (API) calls from an API specification.

18. A non-transitory machine-readable medium having stored thereon machine-readable instructions executable to cause a machine to perform operations comprising:
receiving an intimation call of a data processing request to be processed at a decision service;
determining, based on the decision service and the data processing request, a metadata file for a strategy for a set of rules, wherein the strategy includes a plurality of pathways each having one or more of the set of rules used by the decision service when executing the strategy for the data processing request, and wherein the metadata file indicates the plurality pathways and data dependencies of the set of rules used in each of the plurality of pathways;
loading available data for the data processing request at a first time of the intimation call;
generating a base decision for the decision service from a subset of the plurality of pathways using a rule engine and the available data; and
sending the base decision to at least one of another decision service or a storage for a second time associated with processing the data processing request at the decision service.

19. The non-transitory machine-readable medium of claim 16, wherein the metadata file is generated prior to the receiving the intimation call based on an analysis of the strategy for the plurality of pathways and the data dependencies from a strategy parser.

20. The non-transitory machine-readable medium of claim 16, wherein the operations further comprise:
merging the base decision with a further decision from an execution of further ones of the plurality of pathways at the second time.
